(19) United States
(12) Patent Application Publication
(10) Pub. No.: US 2015/0173137 A1
(43) Pub. Date: Jun. 18, 2015

(54) LIGHT-EMITTING DEVICE

(71) Applicant: SHARP KABUSHIKI KAISHA, Osaka-shi, Osaka (JP)

(72) Inventors: Takashi Ono, Osaka-shi (JP); Hideshi Koizumi, Osaka-shi (JP); Kohji Miyake, Osaka-shi (JP)

(21) Appl. No.: 14/413,299

(22) PCT Filed: Jun. 24, 2013
(86) PCT No.: PCT/JP2013/067214

§ 371 Date: Jan. 7, 2015

(30) Foreign Application Priority Data
Jul. 13, 2012 (JP) 2012-157979

(51) Int. Cl. H05B 33/08; F21V 23/00; F21V 23/06; F21S 4/00

(52) U.S. Cl. CPC H05B 33/089; F21S 4/008; F21V 23/002; F21V 23/06; F21V 23/003; F21Y 2113/005

(57) ABSTRACT

Disclosed is a light-emitting device comprising a linear light source (21, 22, and 23) including a linear array of light-emitting elements (21a, 22a, and 23a) on a elongate board (10), the array extending in a direction parallel to a longer side of the board, wherein the light-emitting elements (21a, 22a, and 23a), which constitute the linear light source (21, 22, and 23), are connected in series, a protective element 31, 32, and 33 is connected in parallel with each group of series-connected light-emitting elements, and the protective element (31, 2, and 33) is located on the board (10) and external, with respect to the light-emitting element array direction, to one of the light-emitting elements that is at an end of the array.

### TECHNICAL FIELD

The present invention relates to light-emitting devices used in, for example, amusement machines (e.g., game machines), display devices (e.g., liquid crystal display panels), and lighting devices.

### BACKGROUND ART

Light-emitting elements, such as LEDs (light-emitting diodes), are used as a light source for light-emitting devices used in game machines and other like devices.

FIG. 14 shows an exemplary light-emitting device built around light-emitting elements (see, for example, Patent Document 1). The light-emitting device includes: a linear array of light-emitting elements 511 on an elongate printed board 510, the array extending parallel to a longer side of the board 510; and a sealing resin layer (transparent resin layer) 512 covering the light-emitting elements 511 on the printed board 510, to emit linear light. The light-emitting device described in Patent Document 1 has trough sections 512a and 512b on a surface, opposite the board, of the sealing resin layer 512 covering the light-emitting elements 511 so as to allow outgoing light to be picked up efficiently.

Some light-emitting devices further include protective elements (e.g., Zener diodes) on the board to protect the light-emitting elements (LEDs) from electrostatic destruction (see, for example, Patent Document 2).

### CITATION LIST

### Patent Literature

Patent Document 1: Japanese Patent Application Publication, Tokukai, No. 2009-021221

Patent Document 2: Japanese Patent Application Publication, Tokukai, No. 2008-227423

### SUMMARY OF THE INVENTION

### Problems to be Solved by the Invention

The protective elements, provided in the light-emitting device to ensure a level of electrostatic breakdown voltage, are connected in parallel with the light-emitting elements that constitute a linear light source (see, for example, Patent Document 2). The protective elements, thus mounted on the board, inevitably add to the width of the product (as measured parallel to the shorter side of the elongate board), which is undesirable.

The present invention, conceived in view of this problem, has an object to provide a structure for a light-emitting device including a protective element that protects light-emitting elements constituting a linear light source, the structure being capable of retaining a small product width of the light-emitting device.

### Solution to Problem

The present invention, to achieve the object, is a light-emitting device that emits linear light from light-emitting elements as a light source, the device comprising a linear light source including a linear array of light-emitting elements on an elongate board, the array extending in a direction parallel to a longer side of the board, wherein the light-emitting elements, which constitute the linear light source, are connected in series, a protective element is connected in parallel with the series-connected light-emitting elements, and the protective element is located on the board and external, with respect to the array direction, to one of the light-emitting elements that is at an end of the array.

In the present invention, the light-emitting elements, which constitute a linear light source, are connected in series, a protective element is connected in parallel with the series-connected light-emitting elements, and the protective element is located external, with respect to the array direction, to one of the light-emitting elements that is at an end of the array. This configuration reduces the width of the board as measured parallel to a shorter side of the board, i.e., the product width of the light-emitting device. Furthermore, since the protective element is located external, with respect to the array direction, to one of the light-emitting elements that is at an end of the array, the possibility of the outgoing light of the light-emitting elements being blocked by the protective element is advantageously reduced.

In the present invention, if the protective element is located external, with respect to the array direction, to one of the light-emitting elements that is at an end of the array and on an extension of the array of light-emitting elements in the array direction, the product width of the light-emitting device is more effectively reduced. In addition, if the board has formed on a backside thereof a wiring pattern for connecting the protective element in parallel with the array of light-emitting elements (e.g., wiring that extends from a second end back toward a first end of the board to connect the protective element in parallel), the backside being opposite a face of the board on which the light-emitting elements are provided, the product width of the light-emitting device is more effectively reduced.

In the present invention, the light-emitting elements may be light-emitting diodes, and the protective element may be a Zener diode.

Now, the specific configuration of the present invention will be described.

The present invention may involve either a single linear light source including a linear array of light-emitting elements on a board or at least two linear light sources each of which emits light of a different color and includes a linear array of light-emitting elements on a board.

The following is specific examples of the light-emitting device including at least two lines of linear light sources.

A specific exemplary light-emitting device including a first linear light source including a linear array of first light-emitting elements that emit light of a first color, a second linear light source including a linear array of second light-emitting elements that emit light of a second color, and a third linear light source including a linear array of third light-emitting elements that emit light of a third color, each array extending in a single direction (in a direction parallel to a longer side of a board), wherein the first light-emitting elements, which constitute the first linear light source, are connected in series, the second light-emitting elements, which constitute the second linear light source, are connected in series, and the third light-emitting elements, which constitute the third linear light source, are connected in series, and a first protective element is connected in parallel with the series-connected first light-emitting elements, a second protective element is connected in parallel with the series-connected second light-emitting elements, and a third protective element is connected in parallel with the series-connected third light-emitting elements.

In a more specific example, the first light-emitting elements are blue light-emitting elements, the second light-emitting elements are red light-emitting elements, and the third light-emitting elements are green light-emitting elements, and the first linear light source is a blue linear light source, the second linear light source is a red linear light source, and the third linear light source is a green linear light source.

Where there are provided three linear light sources (a blue linear light source, a red linear light source, and a green linear light source) in this manner, the red linear light source, which is constituted by the red light-emitting elements, is located in the middle with respect to a direction in which the three linear light sources are arranged (direction perpendicular to the length of the linear light sources), and the blue linear light source, which is constituted by the blue light-emitting elements, and the green linear light source, which is constituted by the green light-emitting elements, are located on different sides of the red linear light source. Use of this configuration increases efficiency in heat discharging by the light-emitting device. In other words, considering the fact that red light-emitting elements (red LED chips) consume less power W (hence generate less heat) than the blue and green light-emitting elements (blue and green LED chips), the red linear light source (red LED chip) is located in the middle on the board where heat tends to accumulate (“middle” of the three linear light sources with respect to the direction in which linear light sources are arranged), and the blue linear light source (blue LED chip) and the green linear light source (green LED chip) are located on the respective sides of the red linear light source (closer to the respective edges of the board). This structure increases efficiency in heat discharging.

Where there are provided three (first to third) linear light sources and the light-emitting elements that constitute the linear light sources are light-emitting diodes, the light-emitting diodes that constitute the first linear light source (blue linear light source), the light-emitting diodes that constitute the second linear light source (red linear light source), and the light-emitting diodes that constitute the third linear light source (green linear light source) are connected to share a common cathode or anode. Use of such cathode common connection or anode common connection adds to freedom in routing wiring patterns on the board. That in turn more effectively reduces the width of the board as measured parallel to a shorter side of the board, i.e., the product width of the light-emitting device. Use of cathode common connection or anode common connection enables individual drive control of the first linear light source (blue linear light source), the second linear light source (red linear light source), and the third linear light source (green linear light source) in a simple circuit configuration.

If the three linear light sources are driven individually by a drive control device, the light-emitting device becomes capable of emitting light of, for example, single colors (e.g., single-color blue, single-color red, and single-color green) and mixed colors. That allows, for example, applications in game machines where display colors (emitted light colors) are changed according to the progress and content of the game. Another example is applications to display devices and lighting devices where display colors and illumination colors are changed according to the time and season.

### Advantageous Effects of the Invention

In the light-emitting device in accordance with the present invention, light-emitting elements that constitute a linear light source are connected in series, a protective element is connect in parallel with the series-connected light-emitting elements, and the protective element is located external, with respect to the array direction, to one of the light-emitting elements that is at an end of the array. That configuration enables a reduction in the product width of the light-emitting device.

### BRIEF DESCRIPTION OF DRAWINGS

FIG. 1 is a schematic perspective view of an exemplary light-emitting device in accordance with the present invention.

FIG. 2 is a schematic front view of the exemplary light-emitting device in accordance with the present invention. In FIG. 2, no sealing resin layer is shown.

FIG. 3A is an illustration showing the front side of a printed board used in the light-emitting device shown in FIG. 1. In FIG. 3A, there are provided light-emitting diode chips and Zener diode chips on the printed board.

FIG. 3B is an illustration showing the backside of the printed board used in the light-emitting device shown in FIG. 1.

FIG. 4 is a partial cross-sectional view of the light-emitting device shown in FIG. 1.

FIG. 5 is an equivalent circuit diagram showing how a plurality of light-emitting diode chips and Zener diode chips that constitute linear light sources in the light-emitting device shown in FIGS. 1 to 3B are connected.

FIG. 6 is a schematic diagram of a connector being connected to the light-emitting device shown in FIGS. 1 to 3B.

FIG. 7 is a schematic diagram of an exemplary drive control device that controls driving of a light-emitting device.

FIG. 8 is a partial illustration showing the front side of a part of another exemplary printed board. In FIG. 8, there are provided light-emitting diode chips and Zener diode chips on the printed board.

FIG. 9 is a schematic perspective view of another exemplary light-emitting device in accordance with the present invention.

FIG. 10 is a schematic front view of the other exemplary light-emitting device in accordance with the present invention. In FIG. 10, no sealing resin layer is shown.

FIG. 11A an illustration showing the front side of a printed board used in the light-emitting device shown in FIG. 9. In FIG. 11A, there are provided light-emitting diode chips and Zener diode chips on the printed board.

FIG. 11B is an illustration showing the backside of the printed board used in the light-emitting device shown in FIG. 9.

FIG. 12 is an equivalent circuit diagram showing how a plurality of light-emitting diode chips and Zener diode chips that constitute a linear light source in the light-emitting device shown in FIGS. 9 to 11B are connected.

FIG. 13 is a schematic diagram of an exemplary variation of the light-emitting device shown in FIGS. 9 to 11B.

FIG. 14 is a partial perspective view of an exemplary conventional linear light-emitting device.

### DESCRIPTION OF EMBODIMENTS

The following will describe embodiments of the present invention in reference to drawings.

### Embodiment 1

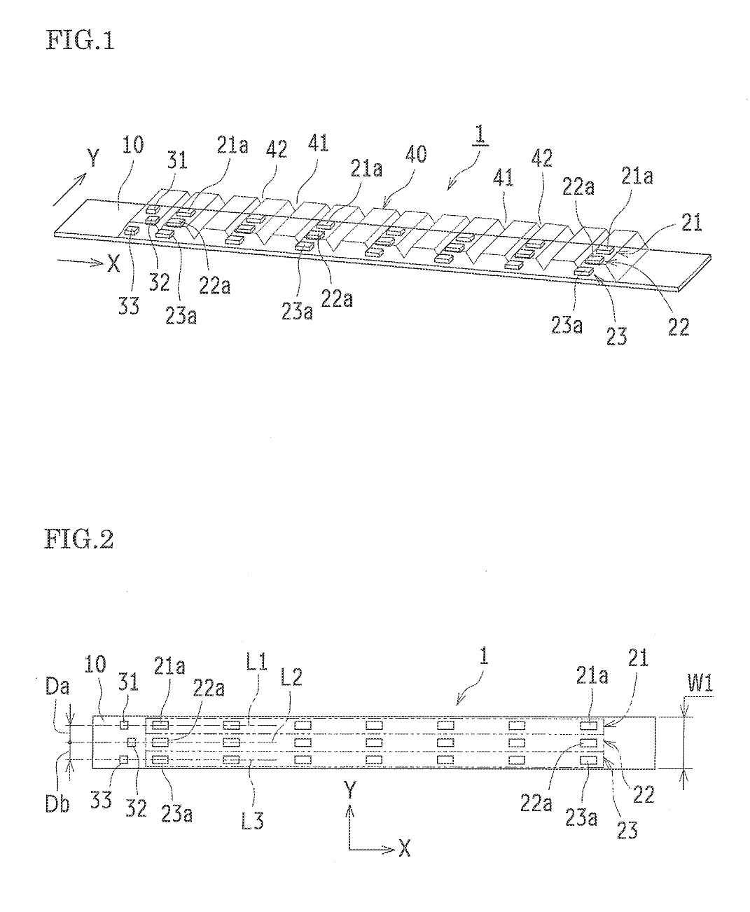

An exemplary light-emitting device in accordance with the present invention will be described in reference to FIGS. 1 to 5.

This exemplary light-emitting device 1 may be used in, for example, amusement machines (e.g., game machines), display devices (e.g., liquid crystal display panels), and lighting devices and is composed of, for example, an elongate printed board 10, a plurality of blue light-emitting diode chips (hereinafter, may be referred to as “blue LED chips”) 21a, a plurality of red light-emitting diode chips (hereinafter, may be referred to as “red LED chips”) 22a, a plurality of green light-emitting diode chips (hereinafter, may be referred to as “green LED chips”) 23a, Zener diode chips (protective elements) 31, 32, and 33, and a sealing resin layer 40.

The printed board 10 is a double-sided printed wiring board having, for example, wiring patterns (detailed later) formed on both the front side and backside of a base material (e.g., white glass BT (bismaleimide triazine)). The blue LED chips 21a, disposed on the printed board 10, are linearly arranged parallel to a longer side of the printed board 10 (direction X) in such a manner that the chips 21a are separated by distances. The blue LED chips 21a constitute a blue linear light source 21. The red LED chips 22a, disposed on the printed board 10, are linearly arranged parallel to direction X in such a manner that the chips 22a are separated by distances. The red LED chips 22a constitute a red linear light source 22. The green LED chips 23a, disposed on the printed board 10, are linearly arranged parallel to direction X in such a manner that the chips 23a are separated by distances. The green LED chips 23a constitute a green linear light source 23.

These three lines (rows) of linear light sources (blue linear light source 21, red linear light source 22, and green linear light source 23) are arranged parallel to each other. The red linear light source 22 is the middle one of the three lines (“middle” one of the three lines of linear light sources 21, 22, and 23 with respect to direction Y, which is perpendicular to direction X). The blue and green linear light sources 21 and 23 are arranged on the respective sides of the red linear light source 22 (closer to the respective edges of the printed board 10).

The three lines of blue, red, and green linear light sources 21, 22, and 23 are located adjacent to each other. The distance Da between the blue linear light source 21 and the red linear light source 22 (center-to-center distance between LED chips, see FIG. 2) is equal to the distance Db between the red linear light source 22 and the green linear light source 23 (center-to-center distance between LED chips, see FIG. 2). To reduce the width W1 of the printed board 10 (product width W1 of the light-emitting device 1) as measured parallel to a shorter side of the printed board 10 (direction Y), the distances Da and Db between the linear light sources are designed to be as small as possible. The distance between a longer-side face (longer-side edge) of the printed board 10 (as opposed to a shorter-side face or edge of the printed board 10) and the blue LED chips 21a and the distance between another longer-side face (longer-side edge) of the printed board 10 and the green LED chips 23a are also designed to be as small as possible.

In the current embodiment, the Zener diode chips 31, 32, and 33 are provided, one for each of the three blue, red, and green linear light sources 21, 22, and 23 (three lines of blue, red, and green LED chips 21a, 22a, and 23a). The Zener diode chips 31, 32, and 33 are protective elements that ensure a level of electrostatic breakdown voltage to protect the LED chips 21a, 22a, and 23a from electrostatic destruction. The Zener diode chips 31, 32, and 33 are disposed on the printed board 10.

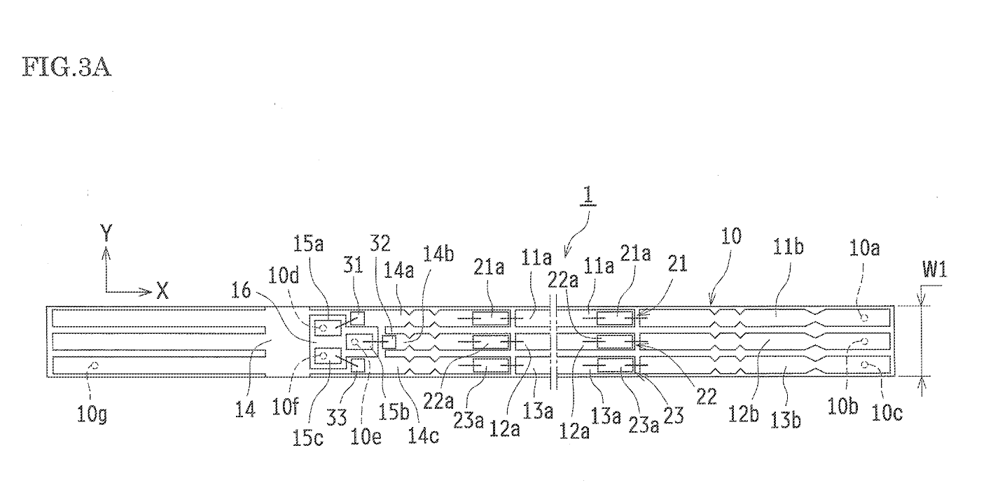

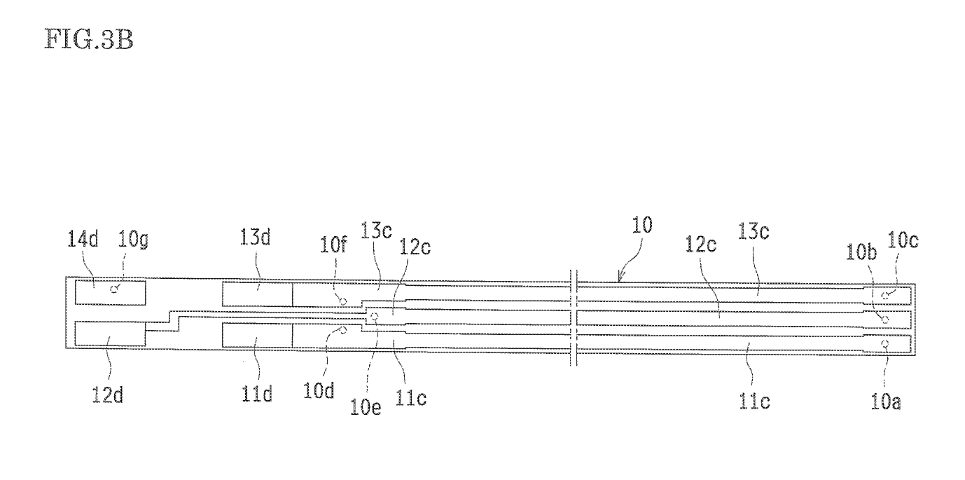

Among the three Zener diode chips 31, 32, and 33, the Zener diode chip 31 for the blue line (hereinafter, may be referred to as the “blue-line ZD chip 31”) is located on an extension of the array of blue LED chips 21a (extension in direction X). More specifically, the blue-line ZD chip 31 is located on a straight line L1 (see FIG. 2) passing through the centers of the blue LED chips 21a arranged parallel to the longer side of the printed board 10 (direction X) and external, with respect to the LED chip array direction, to one of the blue LED chips 21a that is at a first end of the array of blue LED chips 21a (leftmost one of the blue LED chips 21a in FIGS. 2 and 3A). The center of the blue-line ZD chip 31 sits on the straight line L1.

The Zener diode chip 32 for the red line (hereinafter, may be referred to as the “red-line ZD chip 32”) is located on an extension of the array of red LED chips 22a (extension in direction X). More specifically, the red-line ZD chip 32 is located on a straight line L2 (see FIG. 2) passing through the centers of the red LED chips 22a arranged parallel to the longer side of the printed board 10 (direction X) and external, with respect to the LED chip array direction, to one of the red LED chips 22a that is at a first end of the array of red LED chips 22a (leftmost one of the red LED chips 22a in FIGS. 2 and 3A). The center of the red-line ZD chip 32 sits on the straight line L2.

The Zener diode chip 33 for the green line (hereinafter, may be referred to as the “green-line ZD chip 33”) is located on an extension of the array of green LED chips 23a (extension in direction X). More specifically, the green-line ZD chip 33 is located on a straight line L3 (see FIG. 2) passing through the centers of the green LED chips 23a arranged parallel to the longer side of the printed board 10 (direction X) and external, with respect to the LED chip array direction, to one of the green LED chips 23a that is at a first end of the array of green LED chips 23a (leftmost one of the green LED chips 23a in FIGS. 2 and 3A). The center of the green-line ZD chip 33 sits on the straight line L3.

The blue-line ZD chip 31 and the red-line ZD chip 32 are displaced relative to each other in direction X. The red-line ZD chip 32 and the green-line ZD chip 33 are also displaced relative to each other in direction X. The blue-line ZD chip 31 and the green-line ZD chip 33 are aligned with respect to direction X.

As illustrated in FIG. 1, the sealing resin layer 40, made of light transmissive resin, is formed on the front side (chip-mounted side) of the printed board 10 to cover the LED chips 21a, 22a, and 23a and the Zener diodes 31, 32, and 33 on the printed board 10.

On the front side of the sealing resin layer 40 (opposite the printed board 10) are there provided first trough sections 41 and second trough sections 42. Each first trough section 41 is disposed in the middle of an adjacent pair of LED chips 21a (22a and 23a). Each second trough section 42 is disposed at a location that corresponds to one of the LED chips 21a (22a and 23a). These first and second trough sections 41 and 42 are grooves with a V-shaped cross-section that extend in direction Y (perpendicular to direction X) in which the three lines of linear light sources 21, 22, and 23 are arranged. Such first and second trough sections 41 and 42, formed in the sealing resin layer 40, enable outgoing light of the LED chips 21a, 22a, and 23a on the printed board 10 to be efficiently picked up externally (see, for example, Japanese Patent Application Publication, Tokukai, No. 2009-021221). In the current embodiment, the sealing resin layer 40 contains no phosphor.

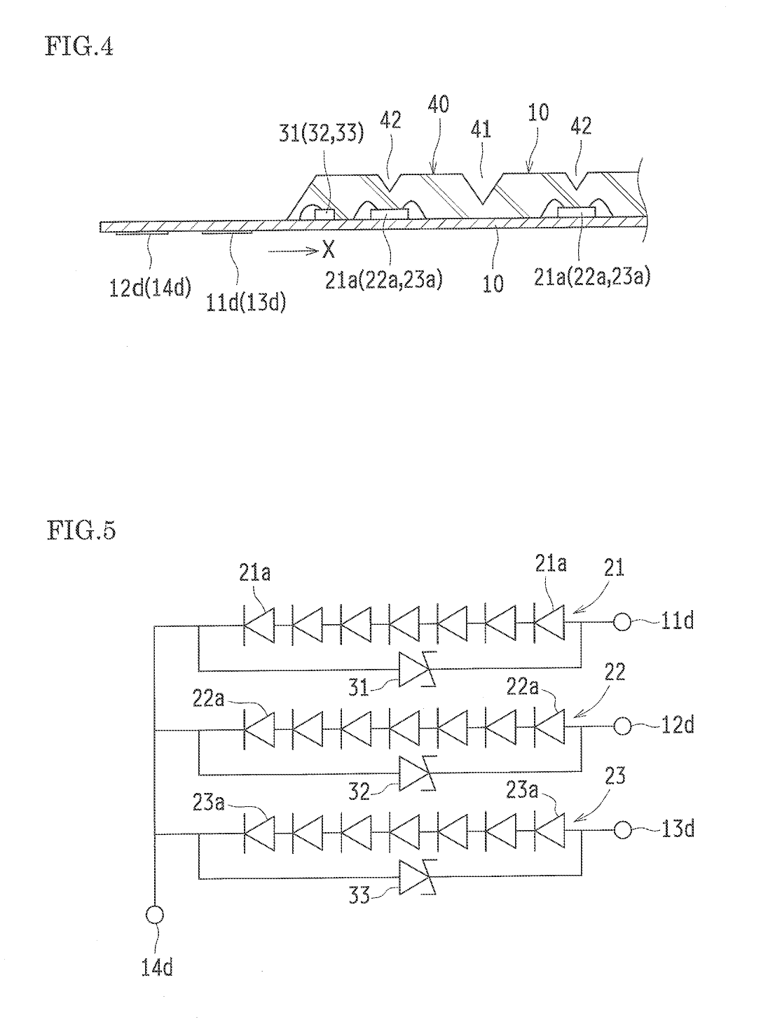

FIG. 4 is a partial cross-sectional view of the light-emitting device 1. As shown also in FIG. 4, the LED chips 21a (22a and 23a) and the Zener diode 31 (32 and 33) on the printed board 10 are covered with the sealing resin layer 40. The first trough sections 41 and the second trough sections 42 are formed on the front side of the sealing resin layer 40 (opposite the printed board 10). Each first trough section 41 is disposed in the middle of an adjacent pair of LED chips 21a (22a and 23a). Each second trough section 42 is disposed at a location that corresponds to one of the LED chips 21a (22a and 23a).

### Circuit Configuration

Now, the circuit configuration of the light-emitting device 1 in accordance with the current embodiment will be described in reference to FIGS. 3A and 3B.

The front side (chip-mounted side) of the printed board 10 has formed thereon an array of connecting wiring patterns 11a and an anode wiring pattern 11b, both for the blue line, an array of connecting wiring patterns 12a and an anode wiring pattern 12b, both for the red line, an array of connecting wiring patterns 13a and an anode wiring pattern 13b, both for the green line, and a cathode common wiring pattern 14. Throughout the following description, connections between the LED chips, the ZD chips, and the various patterns are electrical connections.

Among these wiring patterns, the connecting wiring patterns 12a and the anode wiring pattern 12b, both for the red line, are disposed in the middle with respect to the direction parallel to the shorter side of the printed board 10 (direction Y). The connecting wiring patterns 11a and the anode wiring pattern 11b, both for the blue line, and the connecting wiring patterns 13a and the anode wiring pattern 13b, both for the green line, are disposed on the respective sides of the connecting wiring patterns 12a and the anode wiring pattern 12b.

The anode wiring patterns 11b, 12b, and 13b, respectively for the blue, red, and green lines, are disposed near a second end of the printed board 10 (right-hand side of FIG. 3A) with respect to the direction parallel to the longer side of the printed board 10 (direction X). The cathode common wiring pattern 14 is disposed near a first end of the printed board 10 (left-hand side of FIG. 3A) with respect to the direction parallel to the longer side of the printed board 10. The connecting wiring patterns 11a, 12a, and 13a, respectively for the blue, red, and green lines, are disposed between these anode wiring patterns 11b, 12b, and 13b, respectively for the blue, red, and green lines, and the cathode common wiring pattern 14. The connecting wiring patterns 11a, 12a, and 13a and the anode wiring patterns 11b, 12b, and 13b, respectively for the blue, red, and green lines, are substantially strip-shaped wiring patterns that extend in direction X. The cathode common wiring pattern 14 includes a blue-line connecting section 14a, a red-line connecting section 14b, and a green-line connecting section 14c that have a strip-like shape extending in direction X.

The blue-line connecting wiring patterns 11a are arranged in direction X in such a manner that the connecting wiring patterns 11a are separated by predetermined distances. One of the connecting wiring patterns 11a that is at a second end of the array of connecting wiring patterns 11a (rightmost one of the connecting wiring patterns 11a in FIG. 3A) is located in the proximity of the blue-line anode wiring pattern 11b. One of the connecting wiring patterns 11a that is at a first end of the array of connecting wiring patterns 11a (leftmost one of the connecting wiring patterns 11a in FIG. 3A) is located in the proximity of the blue-line connecting section 14a of the cathode common wiring pattern 14. The blue-line anode wiring pattern 11b, the blue-line connecting wiring patterns 11a, and the blue-line connecting section 14a sit on the same line extending in direction X.

The red-line connecting wiring patterns 12a are arranged in direction X in such a manner that the connecting wiring patterns 12a are separated by predetermined distances. One of the connecting wiring patterns 12a that is at a second end of the array of connecting wiring patterns 12a (rightmost one of the connecting wiring patterns 12a in FIG. 3A) is located in the proximity of the red-line anode wiring pattern 12b. One of the connecting wiring patterns 12a that is at a first end of the array of connecting wiring patterns 12a (leftmost one of the connecting wiring patterns 12a in FIG. 3A) is located in the proximity of the red-line connecting section 14b of the cathode common wiring pattern 14. The red-line anode wiring pattern 12b, the red-line connecting wiring patterns 12a, and the red-line connecting section 14b sit on the same line extending in direction X.

The green-line connecting wiring patterns 13a are arranged in direction X in such a manner that the connecting wiring patterns 13a are separated by predetermined distances. One of the connecting wiring patterns 13a that is at a second end of the array of connecting wiring patterns 13a (rightmost one of the connecting wiring patterns 13a in FIG. 3A) is located in the proximity of the green-line anode wiring pattern 13b. One of the connecting wiring patterns 13a that is at a first end of the array of connecting wiring patterns 13a (leftmost one of the connecting wiring patterns 13a in FIG. 3A) is located in the proximity of the green-line connecting section 14c of the cathode common wiring pattern 14. The green-line anode wiring pattern 13b, the green-line connecting wiring patterns 13a, and the green-line connecting section 14c sit on the same line extending in direction X.

The blue LED chips (double surface electrode type) 21a, provided at an end (second end) of the blue-line connecting section 14a of the cathode common wiring pattern 14, have their cathodes being connected to the blue-line connecting section 14a by wire bonding and their anodes being connected to one of the blue-line connecting wiring patterns 11a that is adjacent to the blue-line connecting section 14a also by wire bonding. Each one of the connecting wiring patterns 11a is provided with one of the blue LED chips 21a that has its cathode being connected by wire bonding to the connecting wiring pattern 11a on which that one of the blue LED chips 21a is provided and its anode being connected by wire bonding to an adjacent one of the connecting wiring patterns 11a. Note that the anode of the blue LED chip 21a provided on one of the connecting wiring patterns 11a that is at the second end of the array of connecting wiring patterns 11a is connected to the blue-line anode wiring pattern 11b. This wiring (connections) connects in series the blue LED chips 21a that constitute the blue linear light source 21.

The red LED chips (double surface electrode type) 22a, provided at an end (second end) of the red-line connecting section 14b of the cathode common wiring pattern 14, have their cathodes being connected to the red-line connecting section 14b by wire bonding and their anodes being connected to one of the red-line connecting wiring patterns 12a that is adjacent to the red-line connecting section 14b also by wire bonding. Each one of the connecting wiring patterns 12a is provided with one of the red LED chips 22a that has its cathode being connected by wire bonding to the connecting wiring pattern 12a on which that one of the red LED chips 22a is provided and its anode being connected by wire bonding to an adjacent one of the connecting wiring patterns 12a. Note that the anode of the red LED chip 22a provided on one of the connecting wiring patterns 12a that is at the second end of the array of connecting wiring patterns 12a is connected to the red-line anode wiring pattern 12b.

The green LED chips (double surface electrode type) 23a, provided at an end (second end) of the green-line connecting section 14c of the cathode common wiring pattern 14, have their cathodes being connected to the green-line connecting section 14c by wire bonding and their anodes being connected to one of the green-line connecting wiring patterns 13a that is adjacent to the green-line connecting section 14c also by wire bonding. Each one of the connecting wiring patterns 13a is provided with one of the green LED chips 23a that has its cathode being connected by wire bonding to the connecting wiring pattern 13a on which that one of the green LED chips 23a is provided and its anode being connected by wire bonding to an adjacent one of the connecting wiring patterns 13a. Note that the anode of the green LED chip 23a provided on one of the connecting wiring patterns 13a that is at the second end of the array of connecting wiring patterns 13a is connected to the green-line anode wiring pattern 13b.

The cathode common wiring pattern 14 for the printed board 10 is provided with the ZD chips 31, 32, and 33 respectively for the blue, red, and green lines. As mentioned earlier, these three ZD chips 31, 32, and 33 are respectively disposed external, with respect to the LED chip array direction, to the blue, red, and green LED chips 21a, 22a, and 23a that are at the first ends of the arrays of LED chips. A part of the cathode common wiring pattern 14 is removed in the proximity of the three ZD chips 31, 32, and 33 to provide an opening that serves as a wire bonding area 16 for the Zener diodes 31, 32, and 33.

The wire bonding area 16 has formed therein a wire bonding pad 15a for the blue line, a wire bonding pad 15b for the red line, and a wire bonding pad 15c for the green line. The blue-line wire bonding pad 15a and the red-line wire bonding pad 15b are displaced relative to each other in direction X. The red-line wire bonding pad 15b and the green-line wire bonding pad 15c are displaced relative to each other in direction X. This arrangement enables a reduction in the width of the printed board 10 as measured parallel to the shorter side of the printed board 10 (direction Y), (i.e., the product width W1 of the light-emitting device 1). The blue-line wire bonding pad 15a and the green-line wire bonding pad 15c are aligned with respect to direction X.

The relatively displaced blue- and red-line wire bonding pads 15a and 15b may be positioned to partially overlap with respect to direction X. The relatively displaced red- and green-line wire bonding pads 15b and 15c may be positioned to partially overlap with respect to direction X. Overlapping parts of the displaced wire bonding pads in this manner enables a reduction in the dimension of the printed board 10 that is parallel to the longer side of the printed board 10 (product length).

The blue- and green-line wire bonding pads 15a and 15c may be displaced relative to each other in direction X.

The blue-, red-, and green-line ZD chips 31, 32, and 33 are of an upper/lower electrode type.

The blue-line ZD chip 31 is die-bonded onto the cathode common wiring pattern 14 and has its anode being connected to the cathode common wiring pattern 14 and its cathode being connected to the blue-line wire bonding pad 15a (anode wiring pattern 11c) by wire bonding.

The red-line ZD chip 32 is die-bonded onto the cathode common wiring pattern 14 and has its anode being connected to the cathode common wiring pattern 14 and its cathode being connected to the red-line wire bonding pad 15b (anode wiring pattern 12c) by wire bonding.

The green-line ZD chip 33 is die-bonded onto the cathode common wiring pattern 14 and has its anode being connected to the cathode common wiring pattern 14 and its cathode being connected to the green-line wire bonding pad 15c (anode wiring pattern 13c) by wire bonding.

In contrast, the backside of the printed board 10 (opposite the LED/ZD chip-mounted side) has formed thereon the blue-line anode wiring pattern 11c, the red-line anode wiring pattern 12c, and the green-line anode wiring pattern 13c. The anode wiring patterns 11c, 12c, and 13c on the backside of the printed board 10, provided for the purpose of extending anode lines back toward the first end of the printed board 10 (left-hand side of FIG. 3B), extend from the second toward the first end of the printed board 10 in direction X.

The blue-line anode wiring pattern 11c on the backside of the printed board 10 is connected to the blue-line anode wiring pattern 11b on the front side of the printed board 10 via a through hole line 10a and to the blue-line wire bonding pad 15a on the front side of the printed board 10 via a through hole line 10d.

The red-line anode wiring pattern 12c on the backside of the printed board 10 is connected to the red-line anode wiring pattern 12b on the front side of the printed board 10 via a through hole line 10b and to the red-line wire bonding pad 15b on the front side of the printed board 10 via a through hole line 10e.

The green-line anode wiring pattern 13c on the backside of the printed board 10 is connected to the green-line anode wiring pattern 13b on the front side of the printed board 10 via a through hole line 10c and to the green-line wire bonding pad 15c on the front side of the printed board 10 via a through hole line 10f.

The anode wiring patterns 11c, 12c, and 13c on the backside of the printed board 10 have formed at their first ends anode terminals 11d, 12d, and 13d respectively. Among the anode terminals 11d, 12d, and 13d, the red-line anode terminal 12d is disposed at the first end of the printed board 10 (left-hand side of FIG. 3B), whereas the blue-line anode terminal 11d and the green-line anode terminal 13d are disposed at positions separated by a predetermined distance from the red-line anode terminal 12d.

On the backside of the printed board 10 is there formed a cathode terminal 14d at the first end of the printed board 10. The cathode terminal 14d on the backside of the printed board 10 is connected to the cathode common wiring pattern 14 on the front side of the printed board 10 via a through hole line 10g.

In the circuit configuration detailed above, as shown in the equivalent circuit diagram in FIG. 5, the blue LED chips 21a that constitute the blue linear light source 21 are connected in series, the red LED chips 22a that constitute the red linear light source 22 are connected in series, and the green LED chips 23a that constitute the green linear light source 23 are connected in series. The series-connected blue, red, and green LED chips 21a, 22a, and 23a are connected to share a common cathode.

The blue-line ZD chip 31 is connected in reverse parallel with the series-connected blue LED chips 21a. The red-line ZD chip 32 is connected in reverse parallel with the series-connected red LED chips 22a. The green-line ZD chip 33 is connected in reverse parallel with the series-connected green LED chips 23a.

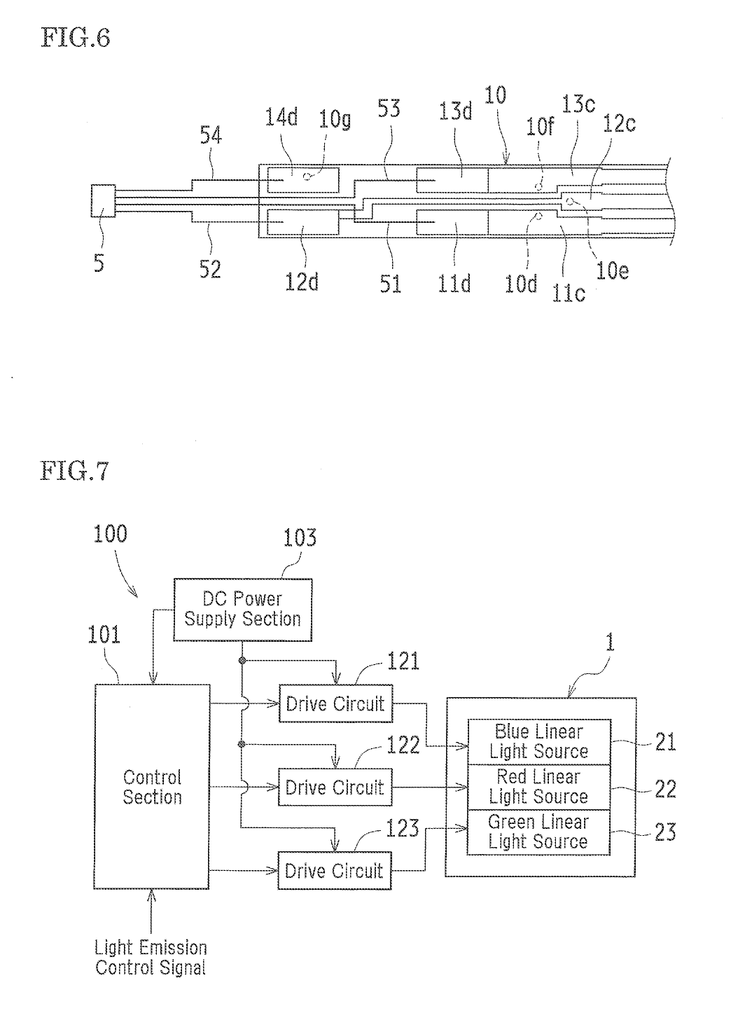

The light-emitting device 1 in accordance with the current embodiment has a structure in which four terminals (three anode terminals 11d, 12d, and 13d, plus a cathode terminal 14d) are formed near the first end of the printed board 10. Lead-connector contacts are also employed so that the light-emitting device 1 can be connected to a drive control device 100 (which will be described later in detail) via a connector. Specifically, as illustrated in FIG. 6, the three anode terminals 11d, 12d, and 13d, provided at the first end of the printed board 10 (left-hand side of FIG. 6), are connected to a connector 5 via leads 51, 52, and 53 respectively, and the cathode terminal 14d is connected to the connector 5 via a lead 54.

### Effects

As described so far, in the light-emitting device 1 in accordance with the current embodiment, (1) the ZD chips 31, 32, and 33, as protective elements connected in parallel with the groups of LED chips that respectively constitute the blue, red, and green linear light sources 21, 22, and 23, are respectively disposed external, with respect to the LED chip array direction, to the blue, red, and green LED chips 21a, 22a, and 23a that are at the first ends of the arrays of LED chips; (2) the backside of the printed board 10 has formed thereon wires (anode wiring patterns 11c, 12c, and 13c) that extend the anode lines for the blue, red, and green linear light sources 21, 22, and 23 from the second end back toward the first end of the printed board 10, to reduce wiring patterns on the front side of the printed board 10; (3) the blue-, red-, and green-line wire bonding pads 15a, 15b, and 15c are displaced relative to each other; and (4) cathode common connection is employed for a common cathode terminal 14d. Such improvements in chip-wiring-electrode configuration enable a reduction in the width W1 of the printed board 10 as measured parallel to the shorter side of the printed board 10 (i.e., the product width W1 of the light-emitting device 1). For example, if each LED and ZD chip measures 300 μm×300 μm, the product width W1 of the light-emitting device 1 is reduced approximately to 1.4 mm.

In the current embodiment, the ZD chips 31, 32, and 33 are disposed external to the LED chips 21a, 22a, and 23a that are at the first ends of the arrays of LED chips. That arrangement reduces the possibility of the outgoing light of the LED chips 21a, 22a, and 23a being blocked by the ZD chips 31, 32, and 33.

In addition, in the current embodiment, considering the fact that the red LED chips 22a consume less power W (hence generate lees heat) than the blue and green LED chips 21a and 23a, the red linear light source 22 constituted by the red LED chips 22a is disposed in the middle on the printed board 10 where heat tends to accumulate (“middle” of the three lines of linear light sources 21, 22, and 23 with respect to direction Y), and the blue linear light source 21 constituted by the blue LED chips 21a and the green linear light source 23 constituted by the green LED chips 23a are disposed on the respective sides of the red linear light source 22 (closer to the respective edges of the printed board 10). This structure increases efficiency in heat discharging.

### Drive Control Device

Next, referring to FIG. 7, a drive control device will be described that controls light emission of the light-emitting device 1.

The exemplary drive control device 100 includes, for example, a control section 101, three drive circuits 121, 122, and 123, and a DC power supply section 103.

Among the three drive circuits 121, 122, and 123, the drive circuit 121 is connected to the anode sides of the blue LED chips 21a that constitute the blue linear light source 21; the drive circuit 122 is connected to the anode sides of the red LED chips 22a that constitute the red linear light source 22; and the drive circuit 123 is connected to the anode sides of the green LED chips 23a that constitute the green linear light source 23.

The drive circuits 121, 122, and 123 are connected to the DC power supply section 103 that supplies electric power to the blue, red, and green linear light sources 21, 22, and 23.

The DC power supply section 103 rectifies AC current of a commercially available AC power supply for conversion to a predetermined voltage and supplies the resultant DC current to the drive circuits 121, 122, and 123 and the control section 101. The DC power supply section 103 may be operable in a mode that allows additional use of a battery (DC) or may be configurable to serve as a DC power supply section by using only a battery (DC).

The control section 101 calculates a drive current, which could be equal to 0, to be supplied to the blue, red, and green linear light sources 21, 22, and 23 according to a light emission control signal (signal for light emission control detailed later) from an external device (e.g., a microcomputer in a game machine, a display device, or a lighting device) and outputs a drive control signal (e.g., a duty signal for each of the linear light sources 21, 22, and 23) to the drive circuits 121, 122, and 123 based on the calculated drive current. The drive circuits 121, 122, and 123 supply a drive current to the blue linear light source 21 (blue LED chips 21a), the red linear light source 22 (red LED chips 22a), and the green linear light source 23 (green LED chips 23a) respectively according to the drive control signal from the control section 101. Such control of drive current supply enables individual light-emission drive control of the blue, red, and green linear light sources 21, 22, and 23.

### Light Emission Control

As mentioned above, in the current embodiment, the blue, red, and green linear light sources 21, 22, and 23 that constitute the light-emitting device 1 can be driven/controlled individually. That enables multicolor linear light emission. Specific examples of light emission control for each color are listed below.

(a) Control by which to supply drive current only to the blue linear light source 21 for single-color (blue) light emission.

(a1) Control by which to intermittently supply (repeatedly turn on/off) drive current only to the blue linear light source 21 for single-color (blue) flashing light emission.

(b) Control by which to supply drive current only to the red linear light source 22 for single-color (red) light emission.

(b1) Control by which to intermittently supply (repeatedly turn on/off) drive current only to the red linear light source 22 for single-color (red) flashing light emission.

(c) Control by which to supply drive current only to the green linear light source 23 for single-color (green) light emission.

(c1) Control by which to intermittently supply (repeatedly turn on/off) drive current only to the green linear light source 23 for single-color (green) flashing light emission.

(d) Control by which to rotate single-color light emission, for example, from blue to red, then to green, at regular intervals (the color sequence is arbitrary).

(e) Control by which to supply drive current to all the blue, red, and green linear light sources 21, 22, and 23 for white light emission.

(f) Control by which to supply drive current to the blue linear light source 21 and the red linear light source 22 for mixed-color (blue and red) light emission (in this control, any mixed-color (composite color) is obtainable by adjusting the ratio of intensities of emitted light of the blue linear light source 21 and the red linear light source 22 in a suitable manner).

(g) Control by which to supply drive current to the blue linear light source 21 and the green linear light source 23 for mixed-color (blue and green) light emission (in this control, any mixed-color (composite color) is obtainable by adjusting the ratio of intensities of emitted light of the blue linear light source 21 and the green linear light source 23 in a suitable manner).

(h) Control by which to supply drive current to the red linear light source 22 and the green linear light source 23 for mixed-color (red and green) light emission (in this control, any mixed-color (composite color) is obtainable by adjusting the ratio of intensities of emitted light of the red linear light source 22 and the green linear light source 23 in a suitable manner).

(i) Control by which to supply drive current to all the blue, red, and green linear light sources 21, 22, and 23 while adjusting the ratio of intensities of emitted light of the blue, red, and green linear light sources 21, 22, and 23 in a suitable manner to emit linear light of any mixed color (composite color) of blue, red, and green.

Light emission control is not limited to these examples and may implement any form of light emission.

### Effects of Light Emission Control

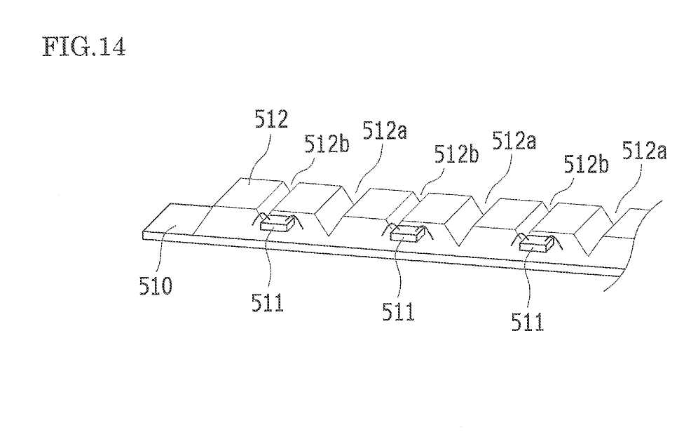

The conventional linear light-emitting device shown in FIG. 14 has a structure where the light emitted by light-emitting elements is directed to enter the sealing resin layer in which phosphor is dispersed, to emit white light. The structure disadvantageously limits the color of emitted light to only one color (white).

In contrast, the light-emitting device 1 in accordance with the current embodiment is capable of emitting light of blue (single-color), red (single-color), green (single-color), white, and various mixed colors. That allows, for example, applications in game machines where display colors (emitted light colors) are changed according to the progress and content of the game. Another example is applications to display devices and lighting devices where display and illumination colors are changed according to the time and season. As can be seen in these examples, the light-emitting device 1 in accordance with the current embodiment is preferably applicable to amusement machines (e.g., game machines), display devices, and lighting devices.

### Exemplary Variations

In embodiment 1 above, the ZD chips 31, 32, and 33 sit on extensions of the arrays of LED chips (extensions in direction X) (on the center lines L1, L2, and L3). This is however not the only possibility. Alternatively, the ZD chips 31, 32, and 33 may be disposed anywhere not on those extensions, provided that the ZD chips 31, 32, and 33 are located external, with respect to the LED chip array direction, to the LED chips 21a, 22a, and 23a that are at the first ends of the arrays of LED chips in such a manner as to be able to reduce the product width W1 of the light-emitting device 1 (the width W1 of the printed board 10).

In embodiment 1 above, the ZD chips 31, 32, and 33 are disposed respectively on the blue-, red-, and green-line connecting sections 14a, 14b, and 14c of the cathode common wiring pattern 14. Alternatively, the ZD chips 31, 32, and 33 may be disposed respectively on the wire bonding pads 15a, 15b, and 15c.

In embodiment 1 above, four terminals (three anode terminals 11d, 12d, and 13d, plus a cathode terminal 14d) are formed near the first end of the printed board 10. Alternatively, the anode terminals 11d, 12d, and 13d may be formed near the second end of the printed board 10 (right-hand side of FIG. 3B) (see FIG. 13).

In embodiment 1 above, the series-connected blue, red, and green LED chips 21a, 22a, and 23a are connected to share a common cathode. This is however not the only possibility. Alternatively, the series-connected blue, red, and green LED chips 21a, 22a, and 23a may be connected to share a common anode.

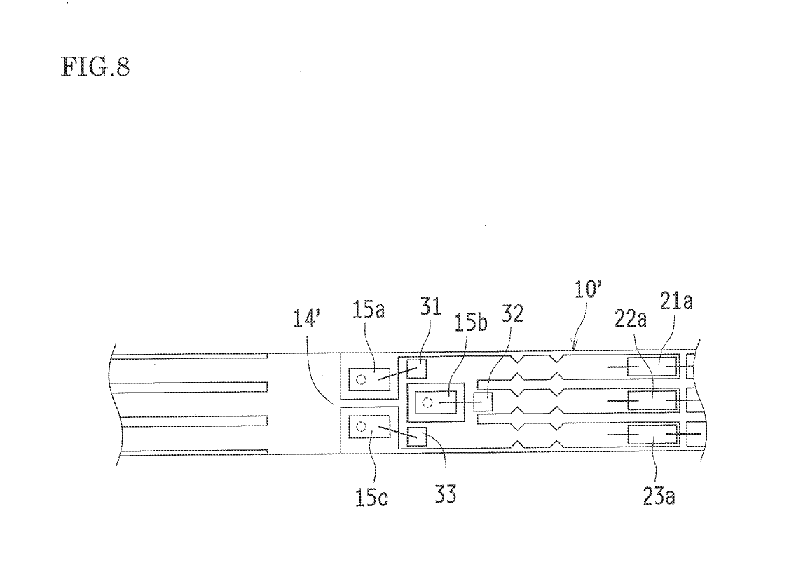

In embodiment 1 above, a part of the cathode common wiring pattern 14 is removed in the proximity of the ZD chips 31, 32, and 33 to provide an opening that serves as a wire bonding area 16 for the Zener diodes 31, 32, and 33. Furthermore, the cathode common wiring pattern 14 is provided on both sides that sandwich the blue-line wire bonding pad 15a and the green-line wire bonding pad 15c (see FIG. 3A). This is not the only possibility. Alternatively, for example, as illustrated in FIG. 8, a cathode common wiring pattern 14′ (single pattern) may be provided between the blue-line wire bonding pad 15a and the green-line wire bonding pad 15c. This structure, shown in FIG. 8, enables a further reduction in the width of the printed board 10′ as measured parallel to the shorter side of the printed board 10′ (i.e., the product width W1 of the light-emitting device 1). For example, if each LED and ZD chip measures 300 μm×300 μm, the product width W1 of the light-emitting device 1 is reduced approximately to 1.31 mm.

In embodiment 1 above, the blue, red, and green LED chips are used.

Alternatively, those LED chips that emit light of any other color may be used to construct three lines of linear light sources that emit light of different colors. In addition, the linear light sources may not necessarily be provided in three lines. The present invention is applicable to light-emitting devices that include two or four or more lines of linear light sources.

In embodiment 1 above, light-emitting diode chips (LED chips) are used as light-emitting elements. This is however by no means intended to limit the present invention. Other light-emitting elements may be used to construct the light-emitting device. For example, blue, red, and green EL (electroluminescence) elements may be used to construct the blue, red, and green linear light sources (21, 22, and 23) shown in FIGS. 1 to 3.

### Embodiment 2

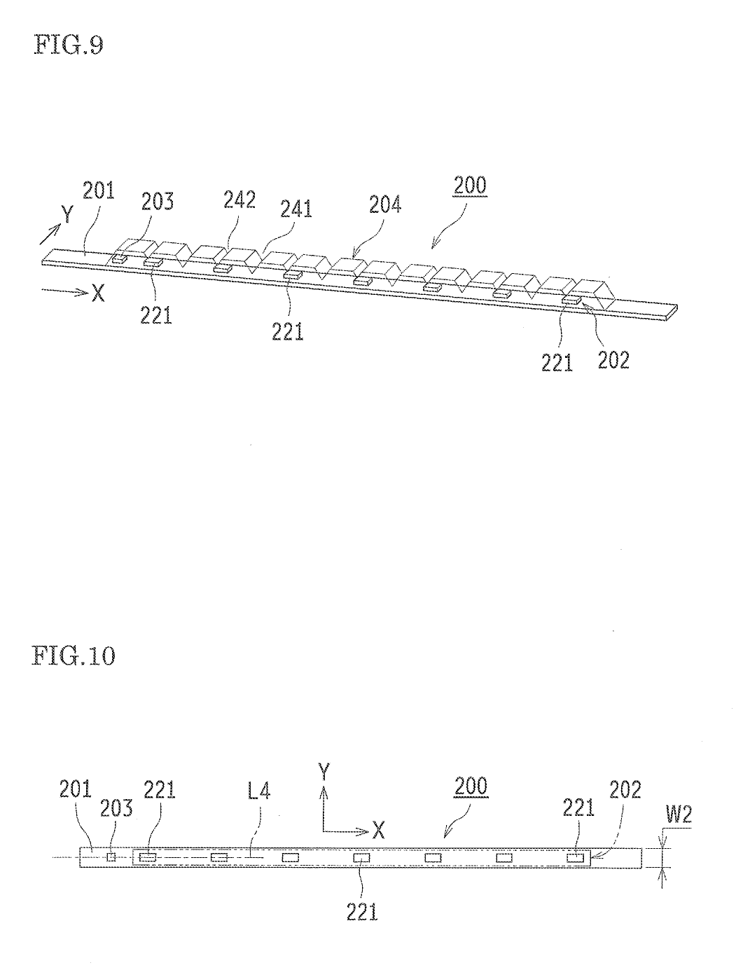

Another exemplary light-emitting device in accordance with the present invention will be described in reference to FIGS. 9 to 12.

This exemplary light-emitting device 200 may be used in, for example, amusement machines (e.g., game machines), display devices (e.g., liquid crystal display panels), and lighting devices and is composed of, for example, an elongate printed board 201, a plurality of light-emitting diode chips (hereinafter, may be referred to as “LED chips”) 221, a Zener diode chip (protective element) 203, and a sealing resin layer 204. The LED chips 221 emit, for example, blue light.

The printed board 201 is a double-sided printed wiring board having, for example, wiring patterns (detailed later) formed on both the front side and backside of a base material (e.g., white glass BT (bismaleimide triazine)). The LED chips 221, disposed on the printed board 201, are linearly arranged parallel to a longer side of the printed board 201 (direction X) in such a manner that the chips 221 are separated by distances. The LED chips 221 constitute a linear light source 202. In the current embodiment, to reduce the width W2 of the printed board 201 (product width W2 of the light-emitting device 200) as measured parallel to a shorter side of the printed board 201, the distance between the LED chips 211 and a longer-side face (longer-side edge) of the printed board 201 (as opposed to a shorter-side face or edge of the printed board 201) and the distance between the LED chips 211 and another longer-side face (longer-side edge) of the printed board 201 are designed to be as small as possible.

In the current embodiment, the Zener diode chip 203 (hereinafter, may be referred to as the “ZD chip 203”) is provided for the LED chips 221 that constitute the linear light source 202. The ZD chip 203 is a protective element that ensures a level of electrostatic breakdown voltage to protect the LED chips 221 from electrostatic destruction. The ZD chip 203 is disposed on the printed board 201.

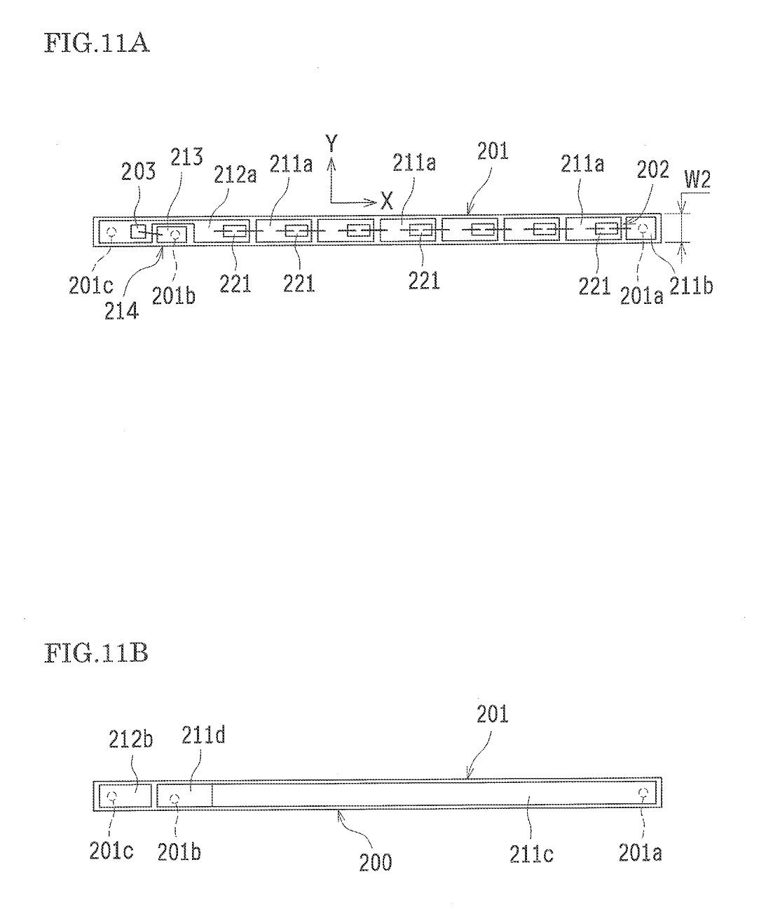

The ZD chip 203 is located on an extension of the array of LED chips 221 (extension in direction X). More specifically, the ZD chip 203 is located on a straight line L4 (see FIG. 10) passing through the centers of the LED chips 221 arranged parallel to the longer side of the printed board 201 (direction X) and external, with respect to the LED chip array direction, to one of the LED chips 221 that is at a first end of the array of LED chips 221 (leftmost one of the LED chips 221 in FIGS. 10 and 11A). The center of the ZD chip 203 sits on the straight line L4.

As illustrated in FIG. 9, the sealing resin layer 204 is formed on the front side (chip-mounted side) of the printed board 201 to cover the LED chips 221 and the ZD chip 203 on the printed board 201. If white light is to be obtained, a phosphor-containing resin is applied to the periphery of the LED chips 221 before forming the sealing resin layer 204. The dispersed phosphor, for example, emits yellow light, and when used in combination with the blue light-emitting LED chips 221, produces white light.

On the front side of the sealing resin layer 204 (opposite the printed board 201) are there provided first trough sections 241 and second trough sections 242. Each first trough section 241 is disposed in the middle of an adjacent pair of LED chips 221. Each second trough section 242 is disposed at a location that corresponds to one of the LED chips 221. These first and second trough sections 241 and 242 are grooves with a V-shaped cross-section that extend in direction Y (perpendicular to the direction of the array of LED chips 221). Such first and second trough sections 241 and 242, formed in the sealing resin layer 204, enable outgoing light of the LED chips 221 on the printed board 201 to be efficiently picked up externally (see, for example, Japanese Patent Application Publication, Tokukai, No. 2009-021221).

### Circuit Configuration

Now, the circuit configuration of the exemplary light-emitting device 200 will be described in reference to FIGS. 11A and 11B.

The front side (chip-mounted side) of the printed board 201 has formed thereon an array of connecting wiring patterns 211a, an anode wiring pattern 211b, and a cathode wiring pattern 212a.

The anode wiring pattern 211b is disposed near a second end of the printed board 201 (right-hand side of FIG. 11A) with respect to the direction parallel to the longer side of the printed board 201. The cathode wiring pattern 212a is disposed near a first end of the printed board 201 (left-hand side of FIG. 11A) with respect to the direction parallel to the longer side of the printed board 201 (direction X). The strip-shaped connecting wiring patterns 211a are disposed between the anode wiring pattern 211b and the cathode wiring pattern 212a.

The connecting wiring patterns 211a are arranged in direction X in such a manner that the connecting wiring patterns 211a are separated by predetermined distances. One of the connecting wiring patterns 211a that is at a second end of the array of connecting wiring patterns 211a (rightmost one of the connecting wiring patterns 211a in FIG. 11A) is located in the proximity of the anode wiring pattern 211b. One of the connecting wiring patterns 211a that is at a first end of the array of connecting wiring patterns 211a (leftmost one of the connecting wiring patterns 211a in FIG. 11A) is located in the proximity of the cathode wiring pattern 212a. The anode wiring pattern 211b, the connecting wiring patterns 211a, and the cathode wiring pattern 212a sit on the same line extending in direction X.

The LED chips (double surface electrode type) 221, provided at an end (second end) of the cathode wiring pattern 212a, have their cathodes being connected to the cathode wiring pattern 212a by wire bonding and their anodes being connected to one of the connecting wiring patterns 211a that is adjacent to the cathode wiring pattern 212a.

The connecting wiring patterns 211a are provided with the LED chips 211 respectively. Each one of the LED chips 221 has its cathode being connected by wire bonding to the connecting wiring pattern 211a on which that one of the LED chips 211 is provided and its anode being connected by wire bonding to an adjacent one of the connecting wiring patterns 211a. Note that the anode of the LED chip 221 provided on one of the connecting wiring patterns 211a that is at the second end of the array of connecting wiring patterns 211a is connected to the anode wiring pattern 211b. This wiring (connections) connects in series the LED chips 221 that constitute the linear light source 202.

The cathode wiring pattern 212a for the printed board 201 is provided with the ZD chip 203. As mentioned earlier, this ZD chip 203 is disposed external, with respect to the LED chip array direction, to the LED chip 221 that is at the first end of the array of LED chips. A part of the cathode wiring pattern 212a is cut off in the proximity of the ZD chip 203 to provide a notch that serves as a wire bonding area 214 for the Zener diode 203. The wire bonding area 214 has formed therein a wire bonding pad 213.

The ZD chip 203 is of an upper/lower electrode type. The ZD chip 203 is die-bonded onto the cathode wiring pattern 212a and has its anode being connected to the cathode wiring pattern 212a and its cathode being connected to the wire bonding pad 213 (anode terminal 211d) by wire bonding.

In contrast, the backside of the printed board 201 (opposite the chip-mounted side) has formed thereon an anode wiring pattern 211c. The anode wiring pattern 211c on the backside of the printed board 201, provided for the purpose of extending an anode line back toward the first end of the printed board 201 (left-hand side of FIG. 11B), extends from the second toward the first end of the printed board 201 in direction X.

The anode wiring pattern 211c on the backside of the printed board 201 is connected to the anode wiring pattern 211b on the front side of the printed board 201 via a through hole line 201a. The anode wiring pattern 211c (anode terminal 211d) on the backside of the printed board 201 is connected to the wire bonding pad 213 on the front side of the printed board 201 via a through hole line 201b. The anode wiring pattern 211c on the backside of the printed board 201 has formed at its first end (first end of the printed board 201) an anode terminal 211d. Note that the anode terminal 211d is disposed at the first end of the printed board 201 because this structure allows two terminals (the anode terminal 211d and a cathode terminal 212b (detailed later)) to be formed near the first end of the printed board 201.

On the backside of the printed board 201 is there formed the cathode terminal 212b at the first end of the printed board 201. The cathode terminal 212b on the backside of the printed board 201 is connected to the cathode wiring pattern 212a on the front side of the printed board 201 via a through hole line 201c.

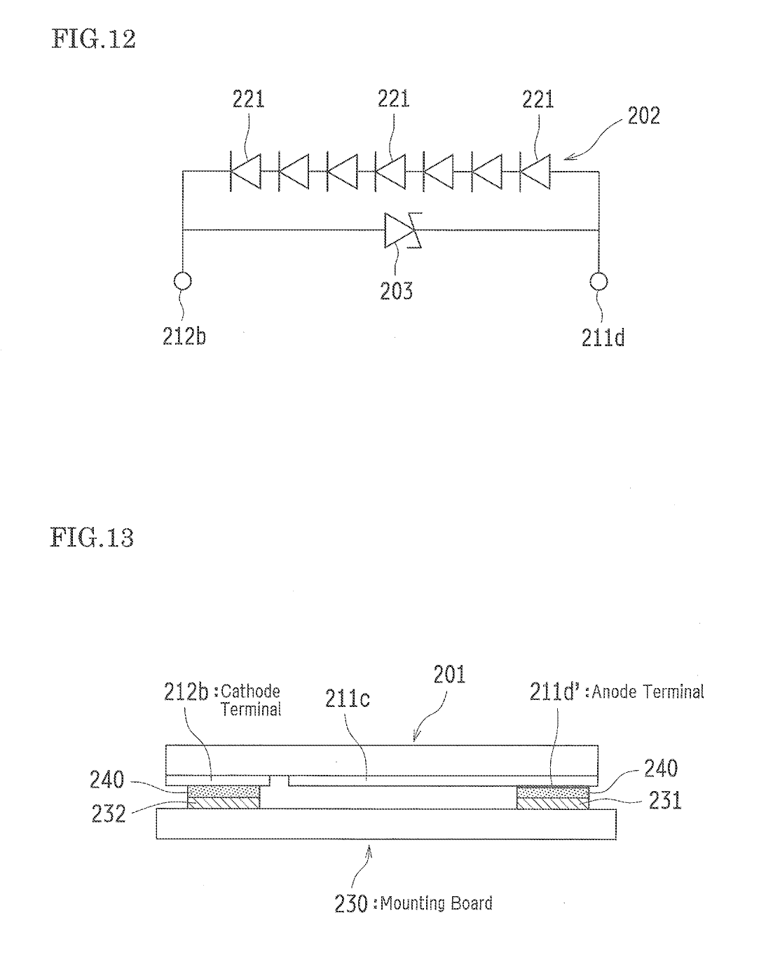

In the circuit configuration detailed above, as shown in the equivalent circuit diagram in FIG. 12, the LED chips 221 that constitute the linear light source 202 are connected in series. The ZD chip 203 is connected in reverse parallel with the series-connected LED chips 221.

The exemplary light-emitting device 200 may be configured so that the driving of the linear light source 202 (supply of drive current to the LED chips 221) can be controlled by a drive control device including, for example, a drive circuit and a control section shown in FIG. 7.

### Effects

As described so far, in the current embodiment, the ZD chip 203 as a protective element connected in parallel with the series-connected LED chips 221 is disposed external, with respect to the LED chip array direction, to the LED chip 221 of each color that is at the first end of the array of LED chips. The backside of the printed board 201 has formed thereon wires (anode wiring pattern 211c) that extend the anode line for the linear light source 202 from the second end back toward the first end of the printed board 201, to reduce wiring patterns on the front side of the printed board 201. Such improvements in chip-wiring-electrode configuration enables a reduction in the width W2 of the printed board 201 as measured parallel to the shorter side of the printed board 201 (i.e., the product width W2 of the light-emitting device 200). For example, if each LED and ZD chip measures 300 μm×300 μm, the product width W2 of the light-emitting device 200 is reduced approximately to 0.4 mm.

In the current embodiment, the ZD chip 203 is disposed external to the LED chip 221 that is at the first end of the array of LED chips. That arrangement reduces the possibility of the outgoing light of the LED chips 221 being blocked by the ZD chip 221.

### Exemplary Variations

In embodiment 2 above, two terminals (anode terminal 211d and cathode terminal 212b) are formed near the first end of the printed board 201. Alternatively, an anode terminal 211d′ may be formed at the second end of the printed board 201, as illustrated in FIG. 13, so that the terminals are provided at both ends of the printed board 201. When this is the case, the cathode terminal 212b and the anode terminal 211d′ disposed at the respective ends of the printed board 201 may be bonded to land patterns 232 and 231 on a mounting board 230 using solder 240 so that the entire light-emitting device 200 can be mounted to the mounting board 230.

In embodiment 2 above, light-emitting diode chips (LED chips) are used as light-emitting elements. This is however by no means intended to limit the present invention. Other light-emitting elements may be used to construct the light-emitting device. For example, EL (electroluminescence) elements may be used to construct the linear light source (202) shown in FIGS. 9 to 11B.

Embodiment 2 above is an exemplary application of the present invention to a light-emitting device that emits white light. This is however not the only possibility. The present invention is also applicable to light-emitting devices that emit, for example, blue, red, or green (single-color) light or non-white, mixed-color light.

The present invention may be implemented in various forms without departing from its spirit and main features. Therefore, the aforementioned examples are for illustrative purposes only in every respect and should not be subjected to any restrictive interpretations. The scope of the present invention is defined only by the claims and never bound by the specification. Those modifications and variations that may lead to equivalents of claimed elements are all included within the scope of the invention.

The present application hereby claims priority on Japanese Patent Application, Tokugan, No. 2012-157979, filed Jul. 13, 2012 in Japan, the entire contents of which are hereby incorporated herein by reference.

### INDUSTRIAL APPLICABILITY

The present invention is applicable to light-emitting devices that emit linear light from a plurality of light-emitting elements as a light source. To describe it in more detail, the present invention is effectively applicable to light-emitting devices that include a protective element to protect light-emitting elements.

### REFERENCE SIGNS LIST

1 Light-emitting Device

10 Printed Board

10a to 10g Through Hole Line

11a Connecting Wiring Pattern (Blue)

11b Anode Wiring Pattern (Front Side)

11c Anode Wiring Pattern (Backside)

11d Anode Terminal

12a Connecting Wiring Pattern (Red)

12b Anode Wiring Pattern (Front Side)

12c Anode Wiring Pattern (Backside)

12d Anode Terminal

13a Connecting Wiring Pattern (Green)

13b Anode Wiring Pattern (Front Side)

13c Anode Wiring Pattern (Backside)

13d Anode Terminal

14 Cathode Common Wiring Pattern

14a Blue-line Connecting Section

14b Red-line Connecting Section

14c Green-line Connecting Section

14d Cathode Terminal

15a, 15b, and 15c Wire Bonding Pad

16 Wire Bonding Area

21 Blue Linear Light Source

21a Blue Light-emitting Diode Chip (Blue LED Chip)

22 Red Linear Light Source

22a Red Light-emitting Diode Chip (Red LED Chip)

23 Green Linear Light Source

23a Red Light-emitting Diode Chip (Red LED Chip)

31, 32, and 33 Zener Diode Chip (ZD Chip)

200 Light-emitting Device

201 Printed Board

201a, 201b, 201c Through Hole Line

211a Connecting Wiring Pattern

211b Anode Wiring Pattern (Front Side)

211c Anode Wiring Pattern (Backside)

211d, 211d′ Anode Terminal

212a Cathode Wiring Pattern

212b Cathode Terminal

203 Zener Diode Chip (ZD Chip)

213 Wire Bonding Pad

214 Wire Bonding Area

1.-12. (canceled)

13. A light-emitting device, comprising a linear light source including a plurality of light-emitting elements on an elongate board, the light-emitting elements being arranged on a linear array of respective wiring patterns extending in a direction parallel to a longer side of the board,
wherein
a protective element is located on an extension that is on the board and external, with respect to an array direction, to one of the light-emitting elements that is at a first end of the array,
the light-emitting elements are connected in series with each other,
the protective element is connected in parallel with the light-emitting elements, and
the board has formed at a second end of the array a second-end wiring pattern for connecting the protective element in parallel with the light-emitting elements, the second-end wiring pattern being provided on a backside of the board and extended back toward the first end of the board so that a first-end terminal of a first-end wiring pattern located at the first end of the array and a second-end terminal of the second-end wiring pattern are formed near a first end of the board, the backside being opposite a face of the board on which the light-emitting elements are provided.

14. The light-emitting device as set forth in claim 13, wherein
the light-emitting elements are light-emitting diodes, and
the protective element is a Zener diode.

15. The light-emitting device as set forth in claim 13, comprising a single linear light source including a linear array of light-emitting elements on the board, the array extending in a direction parallel to the longer side of the board.

16. The light-emitting device as set forth in claim 13, comprising at least two linear light sources each of which emits light of a different color and includes a linear array of light-emitting elements on the board, the array extending in a direction parallel to the longer side of the board.

17. The light-emitting device as set forth in claim 16, comprising a first linear light source including a linear array of first light-emitting elements that emit light of a first color, a second linear light source including a linear array of second light-emitting elements that emit light of a second color, and a third linear light source including a linear array of third light-emitting elements that emit light of a third color, each array extending in a single direction,
wherein the first light-emitting elements, which constitute the first linear light source, are connected in series, the second light-emitting elements, which constitute the second linear light source, are connected in series, and the third light-emitting elements, which constitute the third linear light source, are connected in series, and
a first protective element is connected in parallel with the series-connected first light-emitting elements, a second protective element is connected in parallel with the series-connected second light-emitting elements, and a third protective element is connected in parallel with the series-connected third light-emitting element.

18. The light-emitting device as set forth in claim 17, wherein
the first light-emitting elements are blue light-emitting elements, the second light-emitting elements are red light-emitting elements, and the third light-emitting elements are green light-emitting elements, and
the first linear light source is a blue linear light source, the second linear light source is a red linear light source, and the third linear light source is a green linear light source.

19. The light-emitting device as set forth in claim 18, wherein
the red linear light source, which is constituted by the red light-emitting elements, is located in the middle with respect to a direction in which the three linear light sources are arranged, and
the blue linear light source, which is constituted by the blue light-emitting elements, and the green linear light source, which is constituted by the green light-emitting elements, are located on different sides of the red linear light source.

20. The light-emitting device as set forth in claim 17, wherein
the light-emitting elements that constitute the linear light sources are light-emitting diodes, and
the light-emitting diodes that constitute the first linear light source, the light-emitting diodes that constitute the second linear light source, and the light-emitting diodes that constitute the third linear light source are connected to share a common cathode.

21. The light-emitting device as set forth in claim 17, wherein
the light-emitting elements that constitute the linear light sources are light-emitting diodes, and
the light-emitting diodes that constitute the first linear light source, the light-emitting diodes that constitute the second linear light source, and the light-emitting diodes that constitute the third linear light source are connected to share a common anode.

22. The light-emitting device as set forth in claim 17, wherein
the first linear light source, the second linear light source, and the third linear light source are driven individually by a drive control device.
